(19) United States
(12) Patent Application Publication
(10) Pub. No.: US 2009/0236960 A1
(43) Pub. Date: Sep. 24, 2009

(54) ELECTRIC LAMP AND INTERFERENCE FILM

(75) Inventors: Margot Van Grootel, Eindhoven (NL); Hans Van Sprang, Eindhoven (NL); Johan Marra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,514

(22) PCT Filed: Mar. 16, 2006
(86) PCT No.: PCT/IB05/52852

§ 371 Date: Mar. 1, 2007

(30) Foreign Application Priority Data
Sep. 9, 2004 (EP) 04104276.3

(51) Int. Cl. H01K 1/32

(52) U.S. Cl. 313/112

(57) ABSTRACT

An electric lamp has a light-transmitting lamp vessel (1) in which a light source (2) is arranged. At least a portion of the lamp vessel is provided with an interference film (5) for allowing passage of visible-light radiation and reflecting infrared radiation. The interference film has either a first plurality of alternating layers of Si02 and TiO₂ or a second plurality of alternating layers of SiO₂, TiO₂ and Ta₂O₅. The TiO₂ layers in the first plurality of alternating layers have a geometrical thickness of at most 75 nm by inserting relatively thin Si02 interlayers into the TiO₂ layers, and the SiO₂ interlayers have a geometrical thickness of at least 1 nm and at most 7.5 nm. The TiO₂ layers in the second plurality of alternating layers have a geometrical thickness of at most 25 nm by inserting relatively thin Ta₂O₅ interlayers into the TiO₂ layers, and the Ta₂O₅ interlayers have a geometrical thickness of at least 1 nm and at most 5 nm.

The invention relates to an electric lamp comprising a light-transmitting lamp vessel, in which a light source is arranged, and an interference film for allowing passage of visible-light radiation and reflecting infrared radiation. The interference film comprises a plurality of titanium oxide layers as high-refractive index material and silicon oxide layers as low-refractive index material.

The invention further relates to an interference film for use in an electric lamp.

Thin-film optical interference coatings, also known as interference filters, comprising alternating layers of two or more materials having different refractive indices are well known in the art. Such interference films or coatings are used to selectively reflect and/or transmit light radiation from various portions of the electromagnetic spectrum, such as ultraviolet, visible and infrared (IR) radiation. These interference films are employed in the lighting industry to coat reflectors and lamp envelopes. One application in which these thin-film optical coatings have been found to be useful is in the improvement of the illumination efficiency or efficacy of incandescent and arc lamps by reflecting infrared (IR) radiation emitted by a filament or arc back to the filament or arc while transmitting the visible light portion of the electromagnetic spectrum emitted by the filament or arc. This lowers the amount of electrical energy required to be supplied to the filament or arc to maintain its operating temperature. In other lamp applications, where it is desired to transmit IR radiation, such filters can reflect the shorter wavelength portions of the spectrum, such as ultraviolet and visible light portions emitted by a filament or arc and transmit primarily the infrared portion in order to provide heat radiation with little or no visible light radiation.

Optical interference films, also referred to as optical coatings or optical (interference) filters and used for applications where the interference film will be exposed to high temperatures in excess of 500° C., have been made of alternating layers of refractory metal oxides such as titania (titanium dioxide, TiO₂, n=2.7 for rutile TiO₂), niobia (niobium pentoxide, Nb₂O₅, n=2.35), zirkonia (zirconium oxide, n=2.3), tantala (tantalum pentoxide, Ta₂O₅, n=2.2) and silica (silicon oxide, SiO₂, n=1.45), wherein silica is the low-refractive index material and the titania, niobia, zirkonia or tantala is the high-refractive index material (the values of the respective refractive indices are given at a wavelength λ=550 nm). In halogen lamp applications, these interference films are applied on the outer surface of the quartz lamp vessel containing the light source (filament or arc). The outer surface, and thus the interference film, can reach operating temperatures in the range from 800° C. to 900° C.

Interference films or coatings are applied by using evaporation or (reactive) sputtering techniques and also by chemical vapor deposition (CVD) and low-pressure chemical vapor deposition (LPCVD) processes. These deposition techniques generally produce relatively thick layers which tend to crack and which severely limit the filter design.

The phase stability, oxidation state, and thermal expansion mismatch of the high-refractive index layer materials with the quartz substrate at higher temperatures is a matter of concern. Changes herein may cause delamination of the interference film, for instance, due to thermal mismatch, or may introduce an undesirable degree of light scattering and/or light absorption in the interference film. The high-refractive index materials are normally deposited at temperatures relatively close to room temperature (typically below 250° C.) and are deposited as amorphous or microcrystalline layers. Generally, most high-refractive index layers undergo crystallisation at temperatures above 550° C., for instance, during the electric lamp life (typically several thousands of hours). Crystallisation involves crystal grain growth, which may disturb the optical transparency of the coating through light scattering. In addition, care has to be taken, both during the (physical) layer deposition process and during lamp operation at high temperatures, that the high-refractive index layer material should not become oxygen-deficient, because this generally leads to undesired light absorption.

Optical multilayer interference films comprising titanium oxide and silicon oxide are currently used by various companies, in particular, on cold-mirror reflectors and on small, low-wattage halogen lamps with an operation temperature below approximately 650° C. It is known that these interference films tend to become cloudy (scattering) above 700° C. The use of infrared (IR) reflecting interference films based on titanium oxide and silicon oxide is preferred for reasons of cost, because the relatively large difference in the refractive indices of the respective layer materials allows the use of relatively few layers in the filter design and an overall thinner film stack for realising adequate IR reflection, requiring less time during deposition of the interference film. Nevertheless, although TiO₂ with a refractive index n=2.3 at 550 um is commonly used for low-temperature halogen lamps, no high-index TiO₂/SiO₂ IR-reflecting multilayer interference films on high-temperature (e.g. halogen) electric lamps have been commercialised until now because of the above-mentioned problems with scattering, absorption and/or coating cracking/delamination phenomena when the TiO₂/SiO₂ interference film is exposed to temperatures exceeding 700° C. Around and above this temperature range, internal phase transitions from amorphous to crystalline and/or between different crystalline phases occur, in particular the well-known anatase and rutile type of crystallites, creating scattering crystallites and inducing volume changes. In addition, these transitions affect the temperature-dependent mechanical stresses to which the multilayer stack is exposed, which may subsequently induce layer cracking and/or delamination.

It is an object of the invention to provide an electric lamp of the type described in the opening paragraph with an interference film for allowing passage of visible-light radiation and reflecting IR radiation, the interference film comprising titanium oxide layers as high-refractive index material and silicon oxide as low-refractive index material, said interference film exhibiting an improved performance at elevated temperatures. According to the invention, this object is achieved by an electric lamp comprising:

a light-transmitting lamp vessel, in which a light source is arranged,

at least a portion of the lamp vessel being provided with an interference film for allowing passage of visible-light radiation and reflecting infrared radiation,

the interference film comprising either a first plurality of alternating layers of silicon oxide and titanium oxide or a second plurality of alternating layers of silicon oxide, titanium oxide and tantalum oxide,

the titanium oxide layers in the first plurality of alternating layers having a geometrical thickness of at most 75 um by inserting relatively thin silicon oxide interlayers into the titanium oxide layers, the silicon oxide interlayers having a geometrical thickness of at least 1 nm and at most 7.5 nm,

the titanium oxide layers in the second plurality of alternating layers having a geometrical thickness of at most 25 nm by inserting relatively thin tantalum oxide interlayers into the titanium oxide layers, the tantalum oxide interlayers having a geometrical thickness of at least 1 nm and at most 5 nm.

By introducing relatively thin layers of silicon oxide or relatively thin layers of tantalum oxide into the layers of titanium oxide, temperature-stable, high-refractive index layers of titanium oxide are obtained. In this manner, a nano-laminate is created which is very suitable as a high-refractive index material in optical interference films operating at relatively high temperatures (above 700° C.). An electric lamp with an interference film comprising titanium oxide layers as high-refractive index material having a limited thickness and with thin layers of silicon oxide or tantalum inserted into the titanium oxide layers exhibit an improved performance at elevated temperatures.

According to the invention, the growth of the rutile type of crystallites in the layers of titanium oxide is hampered by the introduction of the relatively thin layers of silicon oxide or of tantalum oxide into the layers of titanium oxide. In addition, it was found by the inventors that the phase transition from anatase to rutile is frozen at a certain mixture of anatase and rutile.

In the known interference films comprising titanium oxide, relatively large grains tend to grow at elevated temperatures. The size of these grains is known to be limited in interference films by the thickness of the titanium oxide layer and, in general, does not exceed twice or three times the thickness of the titanium oxide layer when observed in the plane of the layer. In the known interference films employing titanium oxide as high-refractive index material, grain sizes of over 80 nm are observed, giving rise to visible degradation of the interference film due to light scattering. In addition, in the known interference films with titanium oxide as high-refractive index material, the anatase phase at elevated temperatures (above approximately 550° C.) transforms to the rutile phase leading to an increased density of the titanium oxide layer. Excessive growth of rutile crystals in the known layers of titanium oxide at elevated temperatures (above approximately 700° C.) upsets the regular structure of the interference film and induces undesired light scattering.

By encapsulating the layers of titanium oxide in between relatively thin layers of silicon oxide or relatively thin layers of tantalum oxide and by confining the thickness of the individual layers of titanium oxide, stable layers of titanium oxide having excellent and desirable high-temperature properties are obtained. In interference films with the first plurality of alternating layers, the titanium oxide layers have a geometrical thickness of at most 75 nm while silicon oxide interlayers having a geometrical thickness in the range from 1 nm to approximately 7.5 nm are inserted into the titanium oxide layers. In interference films with the second plurality of alternating layers, the titanium oxide layers have a geometrical thickness of at most 25 nm while tantalum oxide interlayers having a geometrical thickness in the range from 1 nm to approximately 5 nm are inserted into the titanium oxide layers.

The interlayers should preferably have a relatively small thickness, because the interlayers influence (lower) the effective refractive index of the nano-laminate comprising the high-refractive index material. To this end, a preferred embodiment of the electric lamp according to the invention is characterized in that the titanium oxide layers in the first plurality of alternating layers have a geometrical thickness of at most 50 nm and the silicon oxide interlayers have a geometrical thickness in the range from approximately 3 nm to approximately 5 nm. An alternative, preferred embodiment of the electric lamp according to the invention is characterized in that the titanium oxide layers in the second plurality of alternating layers have a geometrical thickness of at most 15 nm and the tantalum oxide interlayers have a geometrical thickness which is less than or equal to approximately 3 nm. Surface roughness of the layers is largely prevented if the titanium oxide layers have layer thicknesses that are less than or equal to approximately 15 nm. In addition, grains of titanium oxide can no longer break through the interlayer.

Due to these relatively thin interlayers introduced into the layers of titanium oxide, the nano-laminate still has a very high “average” refractive index. Experiments have shown that such interference films keep the same optical appearance and refractive index when kept at 800° C. for 70 hours. This index may vary from n=2.3 to n=2.7 (at a wavelength of 550 nm), dependent on the amount of anatase seeds present in the as-deposited material. The grain growth of crystals in the layers of titanium oxide is blocked by the presence of the interlayers in the layers of high-refractive index material and this prevents optical scattering. The interlayers of silicon oxide or tantalum oxide act as grain-growth inhibitors in the titanium oxide layers.

Additional measures can be taken to further improve the stability of the interference film at higher temperatures. A preferred embodiment of the electric lamp according to the invention is characterized in that the lamp vessel is provided with an adhesion layer, for example a silicon oxide larger doped with boron and/or phosphored oxide, between the lamp vessel and the interference film having a geometrical thickness of at least 50 nm. This measure counteracts (sudden) cracking of the interference film and/or its delamination from the lamp vessel. Another preferred embodiment of the electric lamp according to the invention is characterized in that the interference film at a side facing away from the lamp vessel is provided with a layer of silicon oxide having a geometrical thickness of at least 50 nm. Such a capping layer limits the deterioration of the interference film. The silicon oxide “capping” layer on the air side of the interference film provides protection of the interference film, in particular at elevated temperatures.

In the case of the second plurality of alternating layers, relatively small interlayers of tantalum oxide are introduced into the filter design of the interference film. The consequence of the introduction of tantalum oxide as interlayer in layers of titanium oxide is that the interference film comprises three layer materials. Apart from being used as material for the interlayer, layers of tantalum oxide can also be used to deposit “full” layers having a refractive index in between that of titanium oxide and that of silicon oxide. In this manner, the “full” layers can act as a layer material with a refractive index intermediate to the refractive index of that of titanium oxide and silicon oxide. Such interference films comprising layers with three different refractive indices can be advantageously used for suppressing higher orders in the design of interference films. For interference films which allow passage of visible-light radiation and reflect infrared radiation, higher order suppression of bands is necessary in order to obtain a sufficiently broad window in the visible range (from approximately 400 nm to approximately 750 nm) without disturbing peaks in the visible range.

These and other aspects of the invention are apparent from and will be elucidated with reference to the embodiments described hereinafter.

In the drawings:

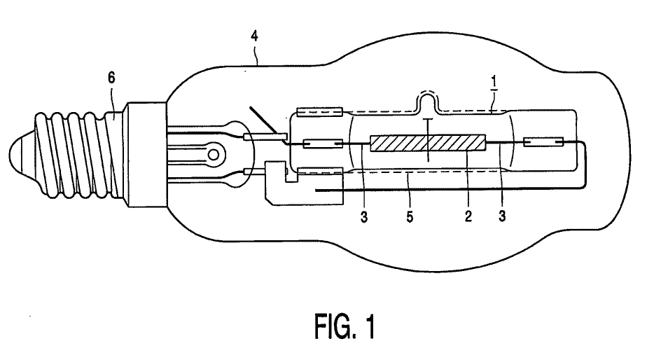

FIG. 1 is a cross-sectional view of an electric incandescent lamp provided with an interference film according to the invention;

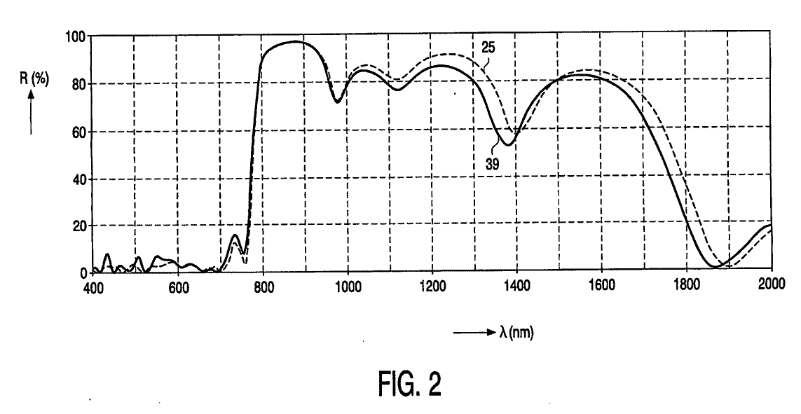

FIG. 2 shows the calculated reflectance of the IR reflecting optical interference films described in Tables IA and IB;

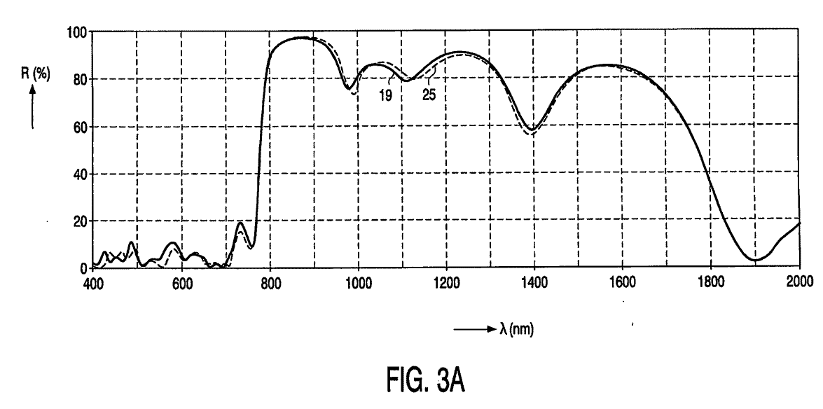

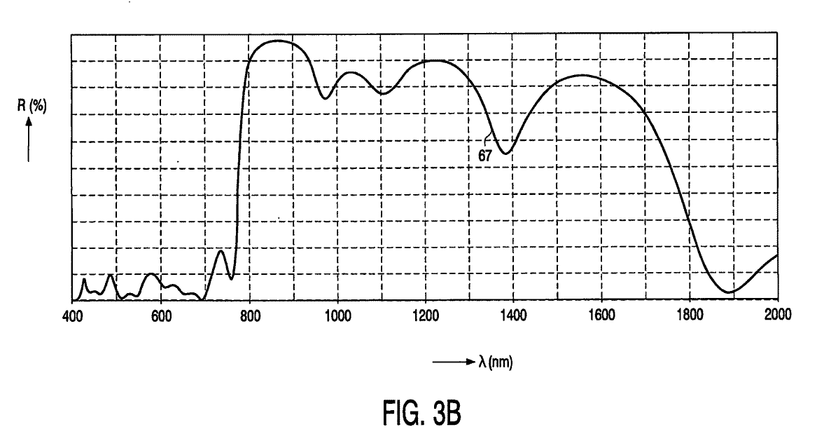

FIG. 3A shows the calculated reflectance of the IR reflecting optical interference films described in Tables IA and IIA;

FIG. 3B shows the calculated reflectance of the IR reflecting optical interference films described in Table IIB;

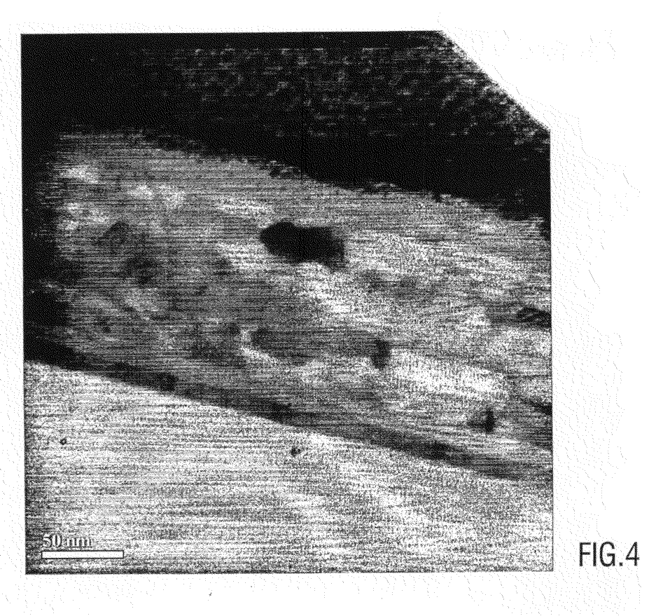

FIG. 4 is a TEM picture of a stack of TiO₂/Ta₂O₅ layers after annealing at 800° C. for 70 hours, and

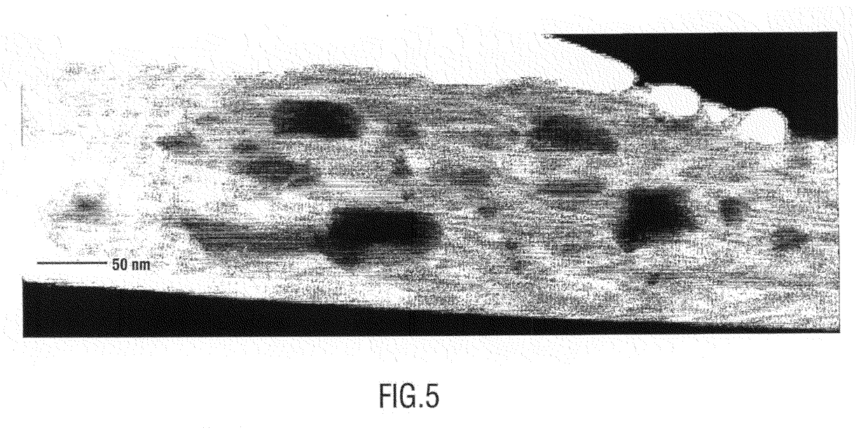

FIG. 5 is a high-angle annular dark-field TEM picture of the stack of TiO₂/Ta₂O₅ as shown in FIG. 4.

The Figures are purely diagrammatic and not drawn to scale. Notably, some dimensions are shown in a strongly exaggerated form for the sake of clarity. Similar components in the Figures are denoted as much as possible by the same reference numerals.

In FIG. 1, the electric lamp comprises a lamp vessel 1 of quartz glass accommodating an incandescent body as the light source 2. Current conductors 3 issuing from the lamp vessel 1 to the exterior are connected to the light source 2. The lamp vessel 1 is filled with a gas containing halogen, for example, hydrogen bromide. At least a part of the lamp vessel 1 is coated with an interference film 5 comprising a plurality of layers of at least silicon oxide and titanium oxide. The interference film 5 allows passage of visible radiation and reflects infrared (IR) radiation. In the example of FIG. 1, the lamp vessel 1 is mounted in an outer bulb 4, which is supported by a lamp cap 6 with which the current conductors 3 are electrically connected. The electric lamp shown in FIG. 1 is a 60 W mains-operated lamp having a service life of at least 2500 hours.

### First Embodiment

A first embodiment of an interference film (first plurality of alternating layers) in a multilayer SiO₂/TiO₂ optical stack design on quartz was set up with the objective of fully transmitting all visible light within the wavelength range from 400 nm<λ<750 nm while reflecting as much as possible the IR light within the range from 750 nm<λ<2000 nm interval. The starting point was an interference film with a relatively small number of layers having a reflectance of infrared light comparable to that of the known interference films. The result is a 25-layer SiO₂/TiO₂ optical interference film stack as shown in Table IA.

TABLE IA
Starting design of a 25-layer IR-reflecting interference
film comprising SiO₂ as low-refractive index material
and TiO₂ as high-refractive index material.

| | | starting design |
|---|---|---|
| Layer | Material | thickness (nm) |
| Medium | Air | — |
| 1 | SiO₂ | 83 |
| 2 | TiO₂ | 84 |
| 3 | SiO₂ | 166 |
| 4 | TiO₂ | 91 |
| 5 | SiO₂ | 164 |
| 6 | TiO₂ | 88 |
| 7 | SiO₂ | 173 |
| 8 | TiO₂ | 19 |
| 9 | SiO₂ | 17 |
| 10 | TiO₂ | 162 |
| 11 | SiO₂ | 15 |
| 12 | TiO₂ | 14 |
| 13 | SiO₂ | 155 |
| 14 | TiO₂ | 9 |
| 15 | SiO₂ | 16 |
| 16 | TiO₂ | 83 |
| 17 | SiO₂ | 24 |
| 18 | TiO₂ | 11 |
| 19 | SiO₂ | 311 |
| 20 | TiO₂ | 11 |
| 21 | SiO₂ | 25 |
| 22 | TiO₂ | 93 |
| 23 | SiO₂ | 25 |
| 24 | TiO₂ | 11 |
| 25 | SiO₂ | 50 |
| Substrate | Quartz | — |

The interference film of Table IA has a total stack thickness of 1904 nm.

In the starting design of the IR interference film of Table IA, two additional layers have been introduced at the end and at the beginning of the interference stack. A first layer (referenced 1) is a SiO₂ layer having a geometrical thickness of at least 50 nm introduced into the interference film at a side facing away from the lamp vessel. The interference film is provided with a layer of silicon oxide having a geometrical thickness of at least 50 nm. Such a capping layer limits the deterioration of the interference film. The silicon oxide “capping” layer on the air side of the interference film provides mechanical protection of the interference film, in particular at elevated temperatures. In the example of Table IA, this capping SiO₂ layer has a thickness of more than 80 nm. A second layer (referenced 25) is a SiO₂ adhesion layer between the lamp vessel and the interference film having a geometrical thickness of 50 nm. This SiO₂ adhesion layer counteracts (sudden) cracking of the interference film and/or its delamination from the lamp vessel. The adhesion layer preferably comprises an oxide chosen from boron oxide and phosphorus oxide. It is known that silicon oxide layers doped with boron oxide and/or phosphorus oxide reduce stresses in the film. The dopes reduce the viscosity of the silicon dioxide. The doping level of the adhesion layer does not need to be more than a few % by weight, so that this layer still has a comparatively high silicon dioxide content, for example, 95% to 98% by weight.

As a subsequent step starting from the 25-layer starting design of Table IA, relatively thin interlayers of silicon oxide are introduced into the thicker layers of titanium oxide. To this end, all TiO₂ layers in the starting design of Table IA having a thickness of more than 50 nm are split up into at least two TiO₂ layers while introducing a relatively thin SiO₂ interlayer in between these two TiO₂ layers. In the example of Table IA, the TiO₂ layers referenced 2, 4, 6, 10, 16 and 22 are split up into two TiO₂ layers with a 4 nm SiO₂ interlayer in between. The resulting design comprising a 39-layer TiO₂/SiO₂ interference film is refined by using computer optimizations, which are known per se, resulting in the optimized design as shown in Table IB.

TABLE IB
Optimized 39-layer IR-reflecting interference film
comprising SiO₂ as low-refractive index material
and TiO₂ as high-refractive index material.

| | | optimized design |
|---|---|---|
| Layer | Material | thickness (nm) |
| Medium | Air | — |
| 1 | SiO₂ | 85 |
| 2 | TiO₂ | 49 |
| 3 | SiO₂ | 4 |
| 4 | TiO₂ | 27 |
| 5 | SiO₂ | 172 |
| 6 | TiO₂ | 46 |
| 7 | SiO₂ | 4 |
| 8 | TiO₂ | 34 |
| 9 | SiO₂ | 170 |
| 10 | TiO₂ | 30 |
| 11 | SiO₂ | 4 |
| 12 | TiO₂ | 50 |
| 13 | SiO₂ | 177 |
| 14 | TiO₂ | 18 |
| 15 | SiO₂ | 21 |
| 16 | TiO₂ | 54 |
| 17 | SiO₂ | 5 |
| 18 | TiO₂ | 50 |
| 19 | SiO₂ | 4 |
| 20 | TiO₂ | 50 |
| 21 | SiO₂ | 18 |
| 22 | TiO₂ | 14 |
| 23 | SiO₂ | 154 |
| 24 | TiO₂ | 12 |
| 25 | SiO₂ | 18 |
| 26 | TiO₂ | 40 |
| 27 | SiO₂ | 4 |
| 28 | TiO₂ | 31 |
| 29 | SiO₂ | 24 |
| 30 | TiO₂ | 11 |
| 31 | SiO₂ | 322 |
| 32 | TiO₂ | 13 |
| 33 | SiO₂ | 25 |
| 34 | TiO₂ | 45 |
| 35 | SiO₂ | 4 |
| 36 | TiO₂ | 39 |
| 37 | SiO₂ | 26 |
| 38 | TiO₂ | 11 |
| 39 | SiO₂ | 50 |
| Substrate | Quartz | — |

The thickness of the TiO₂ layers is limited to 50 nm while introducing 4 nm SiO₂ interlayers into the thicker TiO₂ layers.

The interference film of Table IB has a total stack thickness of 1915 nm, which is approximately the same as the total thickness of the interference film of Table IA.

As can be seen from Table IB, nano-laminates of TiO₂/SiO₂/TiO₂ have been formed with 4 nm SiO₂ interlayers in between two TiO₂ layers having a thickness of at most 50 nm (see layer groups 2-3-4, 6-7-8, 10-11-12, 18-19-20, 26-27-28, and 34-35-39 in Table IB). By introducing relatively thin layers of silicon oxide into the layers of titanium oxide, temperature-stable, high-refractive index layers of titanium oxide are obtained. These nano-laminates are very suitable as high-refractive index material in optical interference films operating at relatively high temperatures (above 700° C.). An electric lamp with an interference film comprising titanium oxide layers as high-refractive index material having a limited thickness and with thin layers of silicon oxide in the titanium oxide layers exhibits an improved performance at elevated temperatures. In this manner, the growth of the rutile type of crystallites in the layers of titanium oxide is hampered by the introduction of the relatively thin layers of silicon oxide into the layers of titanium oxide. In addition, the phase transition from anatase to rutile is frozen at a certain mixture of anatase and rutile.

FIG. 2 shows the calculated reflectance R (in %) as a function of the wavelength λ (in nm) of the IR-reflecting optical interference films described in Table IA (25-layer; broken line referenced “25”) and Table IB (39-layer; solid line referenced “39”). It can be seen that the overall performance of the 39-layer TiO₂/SiO₂ interference film (Table IB) is practically the same as the starting 25-layer TiO₂/SiO₂ interference film (Table IA).

The relevant part of the lamp vessel 1 is covered with the interference film 5 according to Table IB (see FIG. 1) in accordance with the first embodiment of the invention by means of, for instance, reactive sputtering. The interference film 5 according to the invention remained intact and retained its initial properties throughout the service life of the electric lamp.

### Second Embodiment

A second embodiment of an interference film (second plurality of alternating layers) in a multilayer SiO₂/TiO₂ optical stack design on a substrate of SiO₂ was set up with the objective of fully transmitting all visible light within the wavelength range from 400 nm<λ<750 nm while reflecting as much as possible the IR light within the range from 750 nm<λ<2000 nm interval. The starting point was the same interference film as described in Table IA.

In accordance with the second embodiment of the interference film, thin layers of tantalum oxide are introduced into the thick titanium oxide layers. This implies that a third layer material is available. Apart from using tantalum oxide as material for the interlayer, layers of tantalum oxide can also be used to deposit “full” layers having a refractive index in between that of titanium oxide and that of silicon oxide. In this manner, the “full” layers can act as a layer material having a refractive index intermediate to the refractive index of that of titanium oxide and silicon oxide. Such interference films comprising layers having three different refractive indices can be advantageously used for obtaining much simpler filter designs with a reflectance comparable to that of the starting design. In addition, layers having an intermediate refractive index can be used to suppress higher orders in the design of interference films.

The effect of introducing a third layer material having an intermediate refractive index is shown by way of example in Table IIA.

TABLE IIA
19-layer IR-reflecting interference film comprising SiO₂ as low-
refractive index material, TiO₂ oxide as high-refractive index
material, and Ta₂O₅ as intermediate-refractive index material.

| Layer | Material | thickness (nm) |
|---|---|---|
| Medium | Air | — |
| 1 | SiO₂ | 83.4 |
| 2 | TiO₂ | 83.5 |
| 3 | SiO₂ | 165.0 |
| 4 | TiO₂ | 90.4 |
| 5 | SiO₂ | 159.1 |
| 6 | TiO₂ | 87.3 |
| 7 | SiO₂ | 169.8 |
| 8 | Ta₂O₅ | 61.5 |
| 9 | TiO₂ | 138.5 |
| 10 | Ta₂O₅ | 45.2 |
| 11 | SiO₂ | 141.8 |
| 12 | Ta₂O₅ | 39.7 |
| 13 | TiO₂ | 55.9 |
| 14 | Ta₂O₅ | 50.1 |
| 15 | SiO₂ | 307.3 |
| 16 | Ta₂O₅ | 52.7 |
| 17 | TiO₂ | 63.8 |
| 18 | Ta₂O₅ | 48.4 |
| 19 | SiO₂ | 50.0 |
| Substrate | SiO₂ | — |

The interference film of Table IIA has a total stack thickness of 1893 nm, which is approximately the same as the total thickness of the interference film of Table IA.

Although the number of layers is reduced from 25 (Table IA) to 19 (Table IIA), the reflectance of the filter design comprising layers of Ta₂O₅ having a refractive index intermediate to that of SiO₂ and TiO₂ is similar to that of the original 25-layer design (Table IA).

FIG. 3A shows the calculated reflectance R (in %) as a function of the wavelength λ (in mm) of the IP-reflecting optical interference films described in Table IA (25-layer; broken line referenced “25”) and Table IIA (19-layer; solid line referenced “19”). It can be seen that the overall performance of the 19-layer TiO₂/Ta₂O₅/SiO₂ interference film (Table IIA) is practically the same as the starting 25-layer TiO₂/SiO₂ interference film (Table IA).

As a subsequent step starting from the 19-layer TiO₂/Ta₂O₅/SiO₂ interference film (Table IIA), relatively thin interlayers of tantalum oxide are introduced into the thicker layers of titanium oxide. To this end, all TiO₂ layers in the starting design of Table IIA are split up into at least two TiO₂ layers while introducing a relatively thin Ta₂O₅ interlayer in between these two TiO₂ layers. In the example of Table IIA, the TiO₂ layers referenced 2, 4, 6, 9, 13 and 17 are split up into several groups of two TiO₂ layers having a maximum thickness of 15 nm and with a 2 nm Ta₂O₅ interlayer in between. The resulting design is refined by using computer optimizations, which are known per se, resulting in a 67-layer TiO₂/Ta₂O₅/SiO₂ interference design as shown in Table IIB.

TABLE IIB
Optimized 67-layer IR-reflecting interference film comprising SiO₂
as low-refractive index material, TiO₂ oxide as high-refractive
index material, and Ta₂O₅ as intermediate-refractive index material.

| | | optimized design |
|---|---|---|
| Layer | Material | thickness (nm) |
| Medium | Air | — |
| 1 | SiO₂ | 83.6 |
| 2 | TiO₂ | 15.0 |
| 3 | Ta₂O₅ | 2.0 |
| 4 | TiO₂ | 15.0 |
| 5 | Ta₂O₅ | 2.0 |
| 6 | TiO₂ | 15.0 |
| 7 | Ta₂O₅ | 2.0 |
| 8 | TiO₂ | 15.0 |
| 9 | Ta₂O₅ | 2.0 |
| 10 | TiO₂ | 15.0 |
| 11 | SiO₂ | 164.2 |
| 12 | TiO₂ | 8.2 |
| 13 | Ta₂O₅ | 2.0 |
| 14 | TiO₂ | 15.0 |
| 15 | Ta₂O₅ | 2.0 |
| 16 | TiO₂ | 15.0 |
| 17 | Ta₂O₅ | 2.0 |
| 18 | TiO₂ | 15.0 |
| 19 | Ta₂O₅ | 2.0 |
| 20 | TiO₂ | 15.0 |
| 21 | Ta₂O₅ | 2.0 |
| 22 | TiO₂ | 15.0 |
| 23 | SiO₂ | 160.3 |
| 24 | TiO₂ | 18.3 |
| 25 | Ta₂O₅ | 2.0 |
| 26 | TiO₂ | 15.0 |
| 27 | Ta₂O₅ | 2.0 |
| 28 | TiO₂ | 15.0 |
| 29 | Ta₂O₅ | 2.0 |
| 30 | TiO₂ | 15.0 |
| 31 | Ta₂O₅ | 2.0 |
| 32 | TiO₂ | 15.0 |
| 33 | SiO₂ | 170.6 |
| 34 | Ta₂O₅ | 62.1 |
| 35 | TiO₂ | 15.0 |
| 36 | Ta₂O₅ | 2.0 |
| 37 | TiO₂ | 15.0 |
| 38 | Ta₂O₅ | 2.0 |
| 39 | TiO₂ | 15.0 |
| 40 | Ta₂O₅ | 2.0 |
| 41 | TiO₂ | 15.0 |
| 42 | Ta₂O₅ | 2.0 |
| 43 | TiO₂ | 15.0 |
| 44 | Ta₂O₅ | 2.0 |
| 45 | TiO₂ | 15.0 |
| 46 | Ta₂O₅ | 2.0 |
| 47 | TiO₂ | 15.0 |
| 48 | Ta₂O₅ | 2.0 |
| 49 | TiO₂ | 15.0 |
| 50 | Ta₂O₅ | 47.6 |
| 51 | SiO₂ | 150.6 |
| 52 | Ta₂O₅ | 43.4 |
| 53 | TiO₂ | 15.0 |
| 54 | Ta₂O₅ | 2.0 |
| 55 | TiO₂ | 15.0 |
| 56 | Ta₂O₅ | 2.0 |
| 57 | TiO₂ | 15.0 |
| 58 | Ta₂O₅ | 52.1 |
| 59 | SiO₂ | 313.1 |
| 60 | Ta₂O₅ | 56.0 |
| 61 | TiO₂ | 15.0 |
| 62 | Ta₂O₅ | 2.0 |
| 63 | TiO₂ | 15.0 |
| 64 | Ta₂O₅ | 2.0 |
| 65 | TiO₂ | 15.0 |
| 66 | Ta₂O₅ | 53.4 |
| 67 | SiO₂ | 50.0 |
| Substrate | SiO₂ | — |

The thickness of the TiO₂ layers is limited to 15 nm while introducing 2 nm Ta₂O₅ interlayers into the thicker TiO₂ layers.

The interference film of Table IIB has a total stack thickness of 1902 nm, which is approximately the same as the total thickness of the interference films of Table IA and IIA.

As can be seen from Table IIB, nano-laminates of TiO₂/Ta₂O₅/TiO₂ have been formed with 2 nm Ta₂O₅ interlayers in between two TiO₂ layers having a thickness of at most 15 nm (see layer groups 2-10, 12-22, 24-32, 35-49, 53-57, and 61-65 in Table IIB). By introducing relatively thin layers of tantalum oxide into the layers of titanium oxide, temperature-stable, high-refractive index layers of titanium oxide are obtained. These nano-laminates are very suitable as high-refractive index material in optical interference films operating at relatively high temperatures (above 700° C.). An electric lamp with an interference film comprising titanium oxide layers as high-refractive index material having a limited thickness and with thin layers of tantalum oxide in the titanium oxide layers exhibits an improved performance at elevated temperatures. In this manner, the growth of the rutile type of crystallites in the layers of titanium oxide is hampered by the introduction of the relatively thin layers of tantalum oxide into the layers of titanium oxide. In addition, the phase transition from anatase to rutile is frozen at a certain mixture of anatase and rutile.

FIG. 3B shows the calculated reflectance R (in %) as a function of the wavelength λ (in nm) of the IR-reflecting optical interference films described in Table IIB (67-layer; solid line referenced “67”). The 67-layer TiO₂/Ta₂O₅/SiO₂ interference film (Table IIB) has practically the same overall performance as the starting 25-layer TiO₂/SiO₂ interference film (Table IA) and the 19-layer TiO₂/Ta₂O₅/SiO₂ interference film (Table IIA) as shown in FIG. 3A.

The relevant part of the lamp vessel 1 is covered with the interference film 5 (see FIG. 1) according to Table IIB in accordance with the second embodiment of the invention by means of, for instance, reactive sputtering. The interference film 5 according to the invention remained intact and retained its initial properties throughout the service life of the electric lamp.

By way of example, FIG. 4 shows a Transmission Electron Microscope (TEM) picture of a stack of TiO₂/Ta₂O₅ layers after annealing at 800° C. for 70 hours. The bar in the lower left corner of the picture indicates a length of 50 nm. Each TiO₂ layer has a thickness of approximately 10 nm and the Ta₂O₅ interlayers have a thickness of approximately 2 nm. The TiO₂/Ta₂O₅ crystals in the plane of the layer have a grain size of approximately 50 nm.

FIG. 5 is a high-angle annular dark-field (HAADF) TEM picture of the stack of TiO₂/Ta₂O₅ as shown in FIG. 4. In this picture, the white lines on the boundaries of the TiO₂ areas indicate Ta₂O₅. It can be seen that Ta₂O₅ boundary layers confine the TiO₂ to small, relatively flat parts of the layer in which the original composition is retained. No large TiO₂ crystallites penetrating the Ta₂O₅ boundary layers are visible.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electric lamp comprising:
a light-transmitting lamp vessel (1) in which a light source (2) is arranged,
at least a portion of the lamp vessel (1) being provided with an interference film (5) for allowing passage of visible-light radiation and reflecting infrared radiation,
the interference film (5) comprising either a first plurality of alternating layers of silicon oxide and titanium oxide or a second plurality of alternating layers of silicon oxide, titanium oxide and tantalum oxide,
the titanium oxide layers in the first plurality of alternating layers having a geometrical thickness of at most 75 nm by inserting relatively thin silicon oxide interlayers into the titanium oxide layers, the silicon oxide interlayers having a geometrical thickness of at least 1 nm and at most 7.5 nm,
the titanium oxide layers in the second plurality of alternating layers having a geometrical thickness of at most 25 nm by inserting relatively thin tantalum oxide interlayers into the titanium oxide layers, the tantalum oxide interlayers having a geometrical thickness of at least 1 nm and at most 5 nm.

2. An electric lamp as claimed in claim 1, wherein the titanium oxide layers in the first plurality of alternating layers have a geometrical thickness of at most 50 nm and the silicon oxide interlayers have a geometrical thickness of at least 3 nm and at most 5 nm.

3. An electric lamp as claimed in claim 1, wherein the titanium oxide layers in the second plurality of alternating layers have a geometrical thickness of at most 15 nm and the tantalum oxide interlayers have a geometrical thickness of at most 3 nm.

4. An electric lamp as claimed in claim 1, wherein the lamp vessel (2) is provided with an adhesion layer between the lamp vessel (2) and the interference film (5), the adhesion layer having a thickness of at least 50 nm.

5. An electric lamp as claimed in claim 4, wherein the adhesion layer comprises an oxide chosen from boron oxide and phosphorus oxide.

6. An electric lamp as claimed in claim 1, wherein the interference film (5) at a side facing away from the lamp vessel is provided with a layer of silicon oxide having a thickness of at least 50 nm.
